(19) United States
(12) Patent Application Publication
(10) Pub. No.: US 2022/0129793 A1
(43) Pub. Date: Apr. 28, 2022

(54) SYSTEM, METHOD, AND NON-TRANSITORY STORAGE MEDIUM

(71) Applicant: CANON KABUSHIKI KAISHA, Tokyo (JP)

(72) Inventor: Tetsuya SATO, Kanagawa (JP)

(21) Appl. No.: 17/568,163

(22) Filed: Jan. 4, 2022

Related U.S. Application Data
(63) Continuation of application No. PCT/JP2020/019792, filed on May 19, 2020.

(30) Foreign Application Priority Data
Jul. 8, 2019 (JP) 2019-127056

(51) Int. Cl. G06N 20/00

(52) U.S. Cl. CPC G06N 20/00

(57) ABSTRACT

A system managing a first model generated by machine learning, the system comprising: at least one processor and at least one memory functioning as: a substitution unit configured to substitute a first input value included in an input with a second input value when a first prediction result which is a prediction result obtained using the input including the first input value by the first model satisfies a predetermined condition; a preservation unit configured to preserve a second prediction result which is a prediction result obtained using an input obtained through the substitution by the first model; a reception unit configured to receive feedback on the second prediction result; and a generation unit configured to generate a second model by performing machine learning using first learning data formed by the input including the first input value and the second prediction result based on the received feedback.

### CROSS-REFERENCE TO RELATED APPLICATIONS

This application is a Continuation of International Patent Application No. PCT/JP2020/019792, filed May 19, 2020, which claims the benefit of Japanese Patent Application No. 2019-127056, filed Jul. 8, 2019, both of which are hereby incorporated by reference herein in their entirety.

### BACKGROUND OF THE INVENTION

### Field of the Invention

The present invention relates to a system, a method, and a program for managing a learned model of machine learning.

### Background Art

In machine learning, a learning model is adjusted using learning data and the learning model of which the adjustment is completed is actually run as a learned model. In the related art, a prediction system predicting a certain matter using such a learned model is known. For example, PTL 1 discloses a power demand amount prediction method of predicting a power demand amount. PTL 1 discloses a method of replacing a learned model when prediction accuracy is improved further than in a present learned model by learning a learning model with recent learning data.

### CITATION LIST

### Patent Literature

PTL 1: Japanese Patent Application Laid-open No. 2000-276460

Incidentally, an unintended deviation occurs in the above-described learned model in some cases, and thus fairness is not always guaranteed. For example, a system predicting whether to approve a loan of a target person determines whether to approve a loan by a learned model based on input data such as an age, a gender, an income, and the number of work years of the target person. In the learned model, unintended biases such as males being more likely to be predicted to be approved than females and older people being more likely to be predicted to be approved than younger people occur in some cases. When there are such biases in the learned model in operation, it is preferable to correct the biases and guarantee fairness.

However, in the technology of the related art as in PTL 1, no consideration is taken for a bias of a learned model and fairness cannot be guaranteed.

An objective of the present invention is to provide a system capable of correcting a bias of a learned model and guaranteeing fairness.

### SUMMARY OF THE INVENTION

A system managing a first model generated by machine learning, the system comprising: at least one processor and at least one memory functioning as: a substitution unit configured to substitute a first input value included in an input with a second input value when a first prediction result which is a prediction result obtained using the input including the first input value by the first model satisfies a predetermined condition; a preservation unit configured to preserve a second prediction result which is a prediction result obtained using an input obtained through the substitution by the first model; a reception unit configured to receive feedback on the second prediction result; and a generation unit configured to generate a second model by performing machine learning using first learning data formed by the input including the first input value and the second prediction result based on the received feedback.

Further features of the present invention will become apparent from the following description of exemplary embodiments with reference to the attached drawings.

### BRIEF DESCRIPTION OF THE DRAWINGS

FIG. 1 is a schematic diagram illustrating an overall configuration of a system according to a first embodiment of the present invention.

FIG. 2 is a block diagram illustrating an internal configuration of an information processing device included in the system according to the first embodiment of the invention.

FIG. 3A is a block diagram illustrating an example of a functional configuration of a fairness management system 101, FIG. 3B is a block diagram illustrating an example of a functional configuration of a prediction system 102, and FIG. 3C is a block diagram illustrating an example of a functional configuration of a business system 103.

FIG. 4 is a diagram illustrating an example of a UI generated by a presentation unit 301 of the fairness management system 101.

FIG. 5 is a diagram illustrating an example of a U1 generated by a presentation unit 371 of the business system 103.

FIG. 6 is a sequence diagram illustrating processes of the business system 103, the fairness management system 101, and the prediction system 102 until a final result of an examination is fed back from a prediction request of a loan examination to the fairness management system 101.

FIG. 7 is a flowchart illustrating a prediction request rewriting process.

FIG. 8 is a flowchart illustrating a process of replacing a learned model 341 of the prediction system 102 when the fairness management system 101 relearns a learning model.

FIG. 9 is a flowchart illustrating a learning data inflating process.

### DESCRIPTION OF THE EMBODIMENTS

Hereinafter, embodiments of the present invention will be described in detail with reference to the drawings.

First Embodiment

<System Configuration>

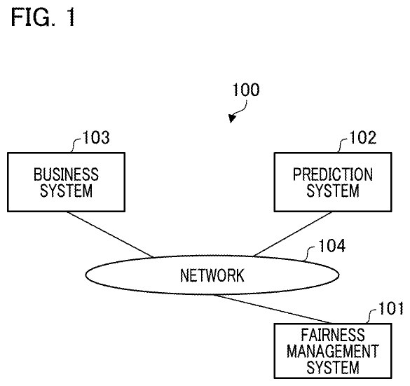

FIG. 1 is a schematic diagram illustrating an overall configuration of a system according to a first embodiment of the embodiment.

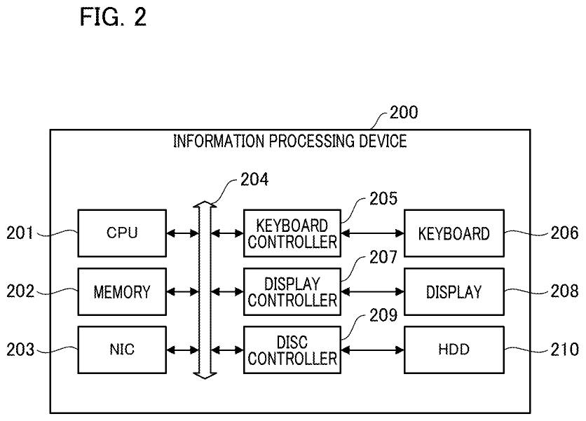

A system 100 according to the first embodiment of the present invention includes a fairness management system 101, a prediction system 102, and a business system 103. The fairness management system 101, the prediction system 102, and the business system 103 are configured by one or more information processing devices. The plurality of systems may be configured by one information processing device. Here, the information processing device is any of various computers such as a personal computer, a visual machine, or the like. The virtual machine is, for example, a virtual computer or the like that emulates an operation with a software program. An information processing device 200 which is an example of the information processing device will be described below with reference to FIG. 2. The fairness management system 101 is a system that monitors whether fairness is guaranteed with a learned model operated with the prediction system 102. The learned model is generated by learning a learning model with learning data. The learned model is a model generated by machine learning.

Here, the fairness is, for example, a judgment of whether a learned model is fair to a user who runs a learned model and receives a prediction result and a user who is actually supplied with a service based on a prediction result. The fairness is, for example, a judgment of whether a learned model is fair to references based on institutions, customs, and cultures in nations and environments in which the learned model is actually run. That is, a reference for determining the fairness is likely to vary in accordance with a user and a usage environment.

In the embodiment, guarantee of the fairness of outputs in which prediction results of the learned models are used can be said to be a state in which the fairness is satisfied for the reference. The reference for determining the fairness can be set by, for example, a user or the like who runs the learned model.

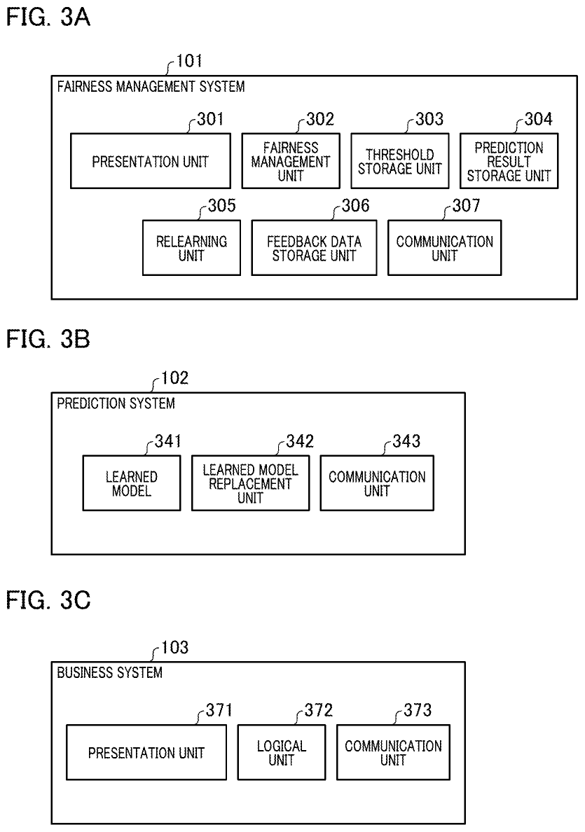

The prediction system 102 is a system that receives a request from the fairness management system 101 and performs prediction using a learned model 341 to be described below with reference to FIG. 3B. The business system 103 is a system that performs a loan examination on application content from a user. The network 104 is a network such as the Internet and the kind of the network does not particularly matter. The fairness management system 101, the prediction system 102, and the business system 103 can perform communication to each other via the network 104.

<Internal Configuration of Information Processing Device>

FIG. 2 is a block diagram illustrating an example of an internal configuration of an information processing device included in the system 100 illustrated in FIG. 1.

Each of the fairness management system 101, the prediction system 102, and the business system 103 illustrated in FIG. 1 is configured by the information processing device 200 in FIG. 2.

The information processing device 200 includes a CPU 201 that executes a program controlling an operation of the system 100 according to the embodiment. “CPU” is an abbreviation for “central processing unit.” The information processing device 200 includes a system bus 204. The CPU 201 generally controls hardware connected to the system bus 204. The information processing device 200 includes an HDD 210 and a disk controller 209. “HDD” is an abbreviation for “hard disk drive.” The HDD 210 is an example of a storage device and is a large-capacity storage device herein. The HDD 210 stores a program which is executed by the CPU 201. The disk controller 209 controls the HDD 210.

The information processing device 200 includes a memory 202. The memory 202 functions as a main memory, a work area, or the like of the CPU 201. The information processing device 200 includes an NIC 203. “NIC” is an abbreviation for “network interface card.” The NIC 203 transmits and receives data to and from another node connected to the network 104 bidirectionally via the network 104. The information processing device 200 includes a keyboard 206 and a keyboard controller 205. A user manipulates the keyboard 206 to input an instruction to the information processing device 200. The keyboard controller 205 performs control such that an input of an instruction with the keyboard 206 is received. The information processing device 200 may not include the keyboard controller 205 and the keyboard 206 depending on its role. The information processing device 200 includes a display 208 and a display controller 207. The display 208 is a display module configured by a liquid crystal display or the like. The display controller 207 performs control of display on the display 208. The information processing device 200 may not include the display 208 and the display controller 207 depending on its role.

<Functional Configuration of Fairness Management System>

FIG. 3A is a block diagram illustrating an example of a functional configuration of the fairness management system 101 illustrated in FIG. 1.

The fairness management system 101 includes a presentation unit 301, a fairness management unit 302, a threshold storage unit 303, a prediction result storage unit 304, a relearning unit 305, a feedback data storage unit 306, and a communication unit 307. Each configuration of the fairness management system 101 illustrated in FIG. 3A is realized by the CPU 201 reading and executing the program stored in the HDD 210 of the fairness management system 101 on the memory 202.

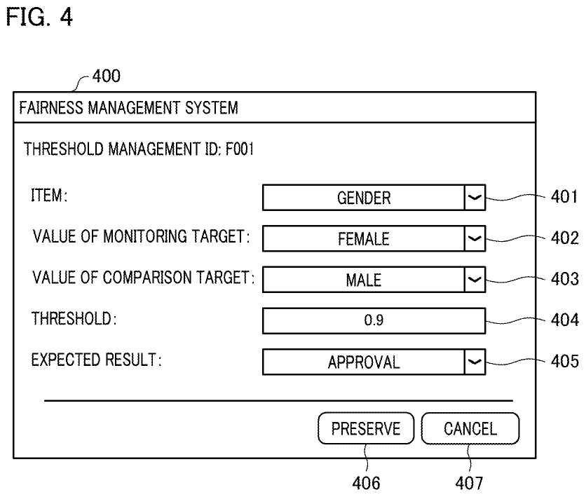

The presentation unit 301 is a software module that generates a UI for setting a threshold indicating fairness. “UI” is an abbreviation for “user interface.” The UI for setting the threshold indicating fairness will be described below with reference to FIG. 4.

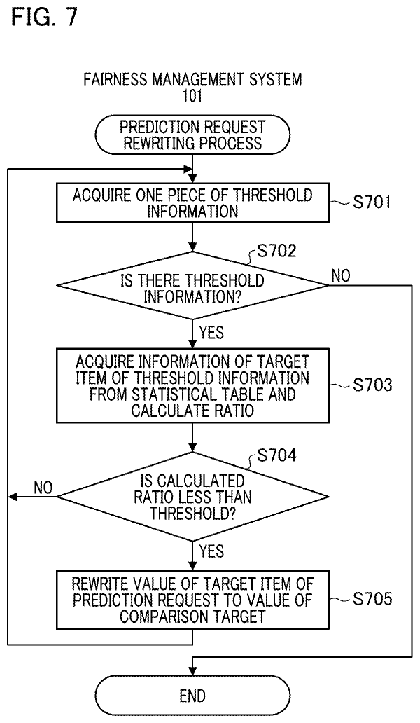

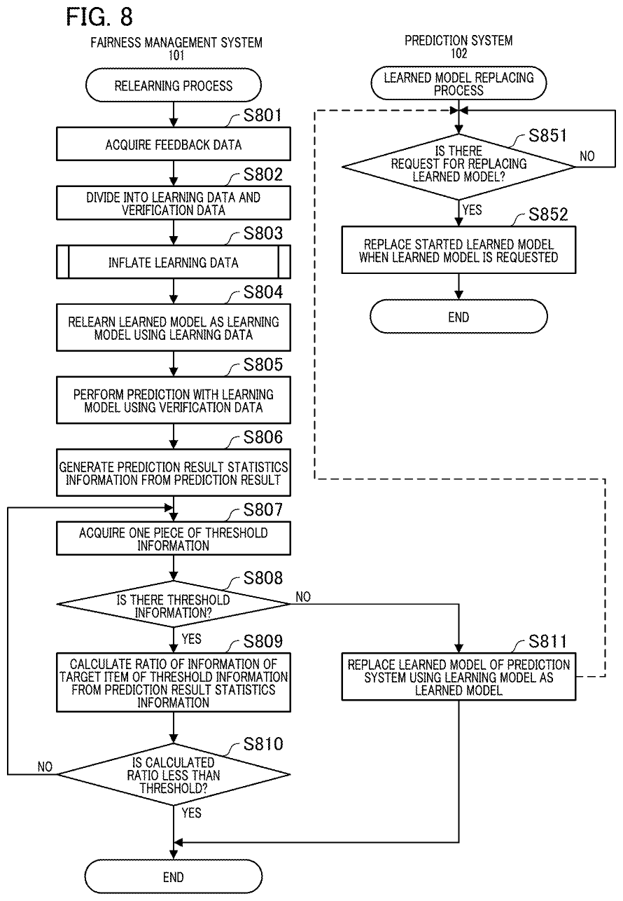

The fairness management unit 302 is a software module that determines whether fairness is guaranteed for a learned model and a learning model. A process of determining whether fairness is guaranteed will be described with reference to FIGS. 7 and 8.

The threshold storage unit 303 is a software module that stores a threshold management table to be described below with reference to Table 1.

The prediction result storage unit 304 is a software module that stores a prediction result management table to be described below with reference to Table 2 and a prediction result statistics table to be described below with reference to Table 3.

The relearning unit 305 is a software module that allows a learned model in the same learned state as that of the learned model 341 of the prediction system 102 which is actually run, to be described below, to be relearned as a learning model.

The feedback data storage unit 306 is a software module that stores a feedback data management table to be described below with reference to Table 4.

The communication unit 307 is a software module that allows the prediction system 102 and the business system 103 to communicate via the network 104.

<Functional Configuration of Prediction System>

FIG. 3B is a block diagram illustrating an example of a functional configuration of the prediction system 102.

The prediction system 102 includes a learned model 341, a learned model replacement unit 342, and a communication unit 343. Each configuration of the prediction system 102 illustrated in FIG. 3B is realized by the CPU 201 reading and executing the program stored in the HDD 210 of the prediction system 102 on the memory 202.

The learned model 341 is a software module that determines whether to approve a loan based on input data such as an age, a gender, an income, and the number of work years of a target person and output a prediction result.

The learned model replacement unit 342 is a software module that replaces the learned model 341.

The communication unit 343 is a software module that communicates with the fairness management system 101 and the business system 103 via the network 104. The prediction system 102 may communicate with the fairness management system 101 and may not communicate with the business system 103.

<Functional Configuration of Business System>

FIG. 3C is a block diagram illustrating an example of a functional configuration of the business system 103.

The business system 103 includes a presentation unit 371, a logical unit 372, and a communication unit 373. Each configuration of the business system 103 illustrated in FIG. 3C is realized by the CPU 201 reading and executing the program stored in the HDD 210 of the business system 103 on the memory 202.

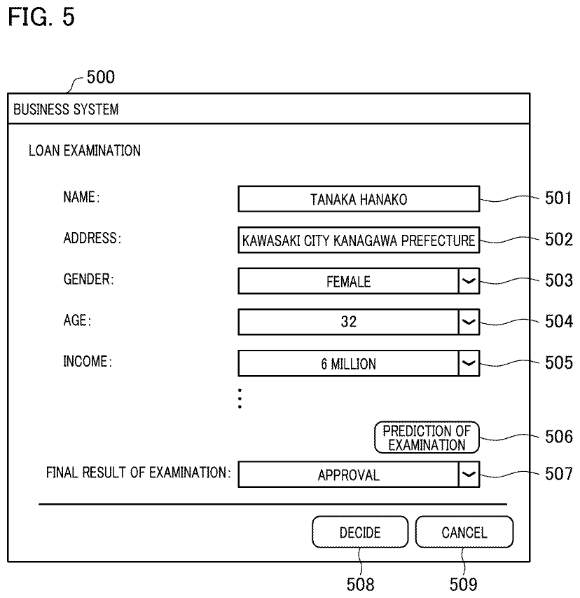

The presentation unit 371 is a software module that receives application content from a user and generates a UI for determining whether to approve a loan. The UI generated by the presentation unit 371 will be described below with reference to FIG. 5.

The logical unit 372 is a software module that processes data delivered from the presentation unit 371.

The communication unit 373 is a software module that allows the fairness management system 101 and the prediction system 102 to communicate via the network 104. The business system 103 may communicate with the fairness management system 101 and may not communicate with the prediction system 102.

<Table Managed by Fairness Management System>

Tables 1 to 4 are examples of tables managed by the fairness management system 101.

TABLE 1

| Threshold | | Value of | Value of | | |
|---|---|---|---|---|---|
| management | | monitoring | comparison | | Expected |
| ID | Item | target | target | Threshold | result |
| F001 | Gender | Female | Male | 0.9 | Approved |
| F002 | Age | 20 to 30 | 30 to 40 | 0.8 | Approved |
| . . . | . . . | . . . | . . . | . . . | . . . |

Table 1 is an example of a threshold management table. The threshold management table is stored in the threshold storage unit 303. In the threshold management table, one record indicates one piece of threshold information. The threshold management table has columns of a threshold management ID, an item, a value of a monitoring target, a value of a comparison target, a threshold, and an expected result.

The threshold management ID is an ID for uniquely identifying threshold information.

The item is an item of input data which the fairness management system 101 monitors to guarantee fairness. For example, the first row of Table 1 indicates that gender is the item to be monitored. Items of the input data monitored to guarantee fairness include gender, nationality, locality, academic background, race, age, and income.

The value of the monitoring target is a value used to monitor whether there is a disadvantage due to a bias of the learned model 341. For example, in the first row of Table 1, a value for monitoring whether there is a disadvantage indicates a female. “Female” which is a monitoring value is an example of a first input value. A prediction result of the learned model 341 using input data in which a gender is “female” is a first prediction result.

The value of the comparison target is a value of the comparison target for determining whether a value of a column of the value of the monitoring target is disadvantageous. For example, the first row of Table 1 indicates that a value of the comparison target is male. “Male,” which is the value of the comparison target, is an example of a second input value.

The threshold is a threshold indicating the extent necessary to guarantee fairness. For example, the first row of Table 1 indicates that the threshold is 0.9.

The expected result indicates which expected result of the learned model 341 is advantageous. For example, the first row of Table 1 indicates who is advantageous when an expected result is approval.

That is, the threshold information in which the threshold management ID in the first row of Table 1 is F001 indicates that female is determined to be disadvantageous because of a bias occurring in the learned model 341 in the item of gender of the input data if an approval ratio of female/approval ratio of male <0.9.

TABLE 2

| Prediction ID | Gender | Age | Income | . . . | Prediction result |
|---|---|---|---|---|---|
| P001 | Male | 28 | 600 | . . . | Approved |
| P002 | Male | 32 | 600 | . . . | Approved |
| P003 | Female | 35 | 800 | . . . | Approved |
| P004 | Female | 23 | 500 | . . . | Unapproved |
| . . . | . . . | . . . | . . . | . . . | . . . |

Table 2 is an example of a prediction result table. The prediction result table is stored in the prediction result storage unit 304. In the prediction result table, one record indicates one piece of prediction result information. The prediction result table has columns of a prediction ID, gender, age, income, and a prediction result.

The prediction ID is an ID that uniquely indicates the prediction result information.

The gender, the age, and the income are items of input data when the fairness management system 101 requests prediction from the prediction system 102. The prediction result table may also additionally have an item of input data such as the number of work years.

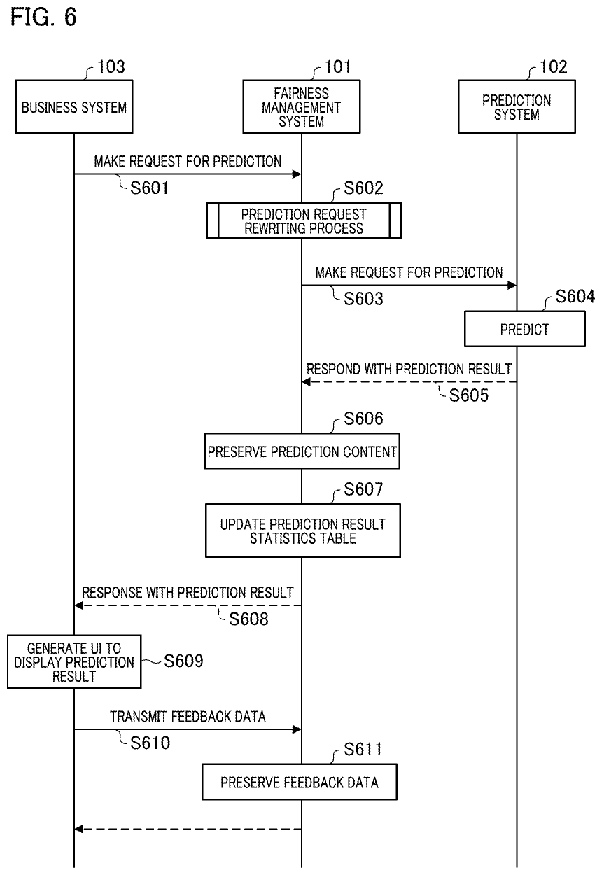

The prediction result is a result predicted by the prediction system 102. A process in which the business system 103 requests the prediction system 102 to predict whether to approve a loan via the fairness management system 101 will be described with reference to FIG. 6.

TABLE 3

| Item | Value | Number of applications | Number of approvals |
|---|---|---|---|
| Gender | Female | 100 | 40 |
| Gender | Male | 200 | 100 |
| Age | 20 to 30 | 150 | 70 |
| Age | 30 to 40 | 100 | 50 |
| . . . | . . . | . . . | . . . |

Table 3 is an example of a prediction result statistics table. The prediction result statistics table is stored in the prediction result storage unit 304. In the prediction result statistics table, one record indicates one piece of prediction result statistics information. The prediction result statistics table has columns of an item, a value, the number of applications, and the number of approvals.

The item is an item of statistical input data.

The value is a value of statistical input data.

The number of applications is a number on which the prediction system 102 is requested to perform prediction.

The number of approvals is a number of prediction results that the prediction system 102 returns as approvals.

For example, the first row of Table 3 indicates that the number of applications in which the gender is female is 100 and the prediction system 102 predicts that 40 are approved among the 100.

TABLE 4

| Feedback data ID | Gender | Age | Income | . . . | Final result |
|---|---|---|---|---|---|
| D001 | Male | 28 | 600 | . . . | Approved |
| D002 | Female | 32 | 600 | . . . | Approved |
| D003 | Female | 35 | 800 | . . . | Approved |
| D004 | Female | 23 | 500 | . . . | Unapproved |
| . . . | . . . | . . . | . . . | . . . | . . . |

Table 4 is an example of a feedback data management table. The feedback data management table is stored in the feedback data storage unit 306. In the feedback data management table, one record indicates one piece of feedback data. The feedback data is information transmitted from the business system 103 to the fairness management system 101, and its process will be described below with reference to FIG. 6. The feedback data management table has columns of a feedback data ID, gender, age, income, and a final result.

The feedback data ID is an ID for uniquely identifying feedback data.

The gender, the age, and the income are items of input data when the business system 103 requests prediction from the fairness management system 101. The feedback data management table may also additionally have an item of input data such as the number of work years.

The final result is a result of determination of loan approval by the business system 103.

<UI of Fairness Management System>

FIG. 4 is a diagram illustrating an example of a UI generated by the presentation unit 301 of the fairness management system 101. For example, the UI is generated by the presentation unit 301 in response to a request from a browser of a PC used by a user of the fairness management system 101 and is displayed on the browser of the PC. “PC” is an abbreviation for “personal computer.” The PC is connected to the network 104 and can communicate with the fairness management system 101. The PC may have a different configuration from the fairness management system 101 or may configure the fairness management system 101.

The browser of the PC connected to the fairness management system 101 displays a threshold information setting screen 400. The threshold information setting screen 400 includes a pull-down 401, a pull-down 402, a pull-down 403, a text box 404, a pull-down 405, a button 406, and a button 407.

The pull-down 401 is a pull-down for setting an item of input data (corresponding to the item in Table 1) which the fairness management system 101 monitors to guarantee fairness.

The pull-down 402 is a pull-down for setting a value (corresponding to the value of the monitoring target in Table 1) used to monitor whether there is a disadvantage due to a bias of the learned model 341.

The pull-down 403 is a pull-down for setting a value of a comparison target (corresponding to the value of the comparison target in Table 1) for determining whether a monitored value set in the pull-down 402 is disadvantageous.

The text box 404 is a text box for setting a value (corresponding to the threshold in Table 1) indicating the extent necessary to guarantee fairness.

The pull-down 405 is a pull-down for setting a result (corresponding to the expected result in Table 1) indicating which expected result of the learned model 341 is advantageous.

The button 406 is a button for setting threshold information with content input on the threshold information setting screen 400. When it is detected that the button 406 is pressed in response to a request from the browser of the PC, the presentation unit 301 preserves the threshold information input on the threshold information setting screen 400 in the threshold management table shown in Table 1 via the threshold storage unit 303.

The button 407 is a button used to cancel the setting of the threshold information.

<Examination Process for Loan Application>

A process in which the business system 103 examines a loan application in cooperation with the fairness management system 101 and the prediction system 102 will be described with reference to FIGS. 5, 6, and 7.

FIG. 5 is a diagram illustrating an example of a UI generated by the presentation unit 371 of the business system 103. For example, the UI is generated by the presentation unit 371 in response to a request from a browser of a PC used by a staff member who examines a loan application and is displayed on the browser of the PC. The PC is connected to the network 104 and can communicate with the business system 103. The PC may have a different configuration from the business system 103 or may have the configuration of the business system 103.

The browser of the PC connected to the business system 103 displays a loan examination screen 500. The loan examination screen 500 includes a text box 501, a text box 502, a pull-down 503, a pull-down 504, a pull-down 505, a button 506, a pull-down 507, a button 506, a button 508, and a button 509.

The text box 501 is a text box for inputting a name of a loan applicant (a target person of loan examination).

The text box 502 is a text box for inputting an address of the loan applicant.

The pull-down 503 is a pull-down for setting a gender of the loan applicant.

The pull-down 504 is a pull-down for setting an age of the loan applicant.

The pull-down 505 is a pull-down for setting an income of the loan applicant.

The loan examination screen 500 may additionally include a control in which information regarding the loan applicant such as the number of work years is input. Here, the control indicates, for example, a UI component such as a text box, a pull-down, or a button.

The button 506 is a button for predicting whether a loan will be approved with information regarding the loan applicant set on the loan examination screen 500. When the button 506 is pressed, the business system 103 receiving the pressing performs a process to be described with reference to FIG. 6.

The pull-down 507 is a pull-down for setting whether to approve a loan. When the button 506 is predicted to be pressed, its prediction result is set in the pull-down 507.

The button 508 is a button for determining whether to approve a loan with content input on the loan examination screen 500.

The button 509 is a button for cancelling the loan examination.

FIG. 6 is a sequence diagram illustrating processes of the business system 103, the fairness management system 101, and the prediction system 102 from a prediction request of a loan examination to feedback of a final result of an examination to the fairness management system 101. The process starts when the presentation unit 371 of the business system 103 detects that a button 506 of the loan examination screen 500 is pressed in response to a request from a browser of a PC.

In step S601, the communication unit 373 of the business system 103 requests the fairness management system 101 to predict a loan examination by using information regarding the loan applicant set on the loan examination screen 500 as input data. Here, as the input data, not all the information regarding the loan applicant set on the loan examination screen 500 need necessarily be used and only data required by the learned model 341 of the prediction system 102 may be used. For example, in the embodiment, a name and an address are not included in the input data, and gender, age, income, and the number of work years are included in the input data. The input data in the embodiment is merely exemplary and necessary input data is determined while analysis of learning data or adjustment such as dimension reduction is performed in learning of a learning model. The learned model 341 is an example of a first model.

In step S602, the fairness management system 101 performs a prediction request rewriting process. Here, the prediction request rewriting process performed by the fairness management system 101 will be described with reference to the flowchart of FIG. 7. FIG. 7 is a flowchart illustrating a prediction request rewriting process.

In step S701, the threshold storage unit 303 acquires one piece of threshold information from the threshold management table shown in Table 1 and the process proceeds to step S702.

In step S702, the fairness management unit 302 determines whether the threshold information can be acquired. When the fairness management unit 302 determines that the threshold information can be acquired, the process proceeds to step S703. When the fairness management unit 302 determines that the threshold information cannot be acquired, the fairness management unit 302 determines that the process of checking all the threshold information ends, and the process ends.

In step S703, the fairness management unit 302 acquires prediction result statistics information matching the item of the threshold information acquired in step S702 via the prediction result storage unit 304 from the prediction result statistics table shown in Table 3. For example, when the threshold management ID of the threshold information acquired in step S702 is F001, a value of the column of the item is gender. Therefore, the fairness management unit 302 acquires records of the first and second rows in which the column of the item is gender among the records of the prediction result statistics table. Then, the fairness management unit 302 calculates a ratio from the acquired prediction result statistics information and the process proceeds to step S704.

For example, when the threshold management ID of the threshold information is F001, the ratio is approval ratio of female/approval ratio of male. Since the number of applications of females based on the prediction result statistics information is 100 and the number of approvals is 40, an approval ratio of females is 0.4. Since the number of applications of males is 200 and the number of approvals is 100, an approval ratio of male is 0.5. Therefore, the ratio is 0.8.

The prediction result “approval” is an example in which a prediction result is a predetermined prediction result. The number of applications is an example of a total prediction number predicted by the first model using an input including the first input value. The number of approvals is an example of the number of times that a prediction result predicted by the first model using the input including the first input value is the predetermined prediction result. The approval ratio of females is an example of a first ratio. The approval ratio of males is an example of a second ratio.

In step S704, the fairness management unit 302 determines whether the ratio calculated in step S703 is less than a threshold of the threshold information acquired in step S701. For example, when the threshold management ID of the threshold information is F001, the value of the column of the threshold in Table 1 is 0.9 and the ratio calculated in step S703 is 0.8, and therefore, the fairness management unit 302 determines that a bias occurs because the ratio is less than the threshold. When the ratio is less than the threshold, the fairness management unit 302 causes the process to proceed to step S705. When the ratio is not less than the threshold, the fairness management unit 302 determines that fairness is guaranteed, and the process proceeds to step S701. The “ratio which is less than the threshold” is an example of a predetermined condition. The “ratio which is less than the threshold” is an example of a case in which a prediction result satisfies the predetermined condition. The “ratio which is not less than the threshold” is an example of a case in which a prediction result does not satisfy the predetermined condition. The predetermined condition is, for example, a condition satisfied when there is a bias between a prediction result obtained using the input including the first input value by the first model and a prediction result obtained using an input including a second input value by the first model.

In step S705, the fairness management unit 302 rewrites the corresponding item of the input data requested to be predicted and received in step S601 to the value of the comparison target of the threshold information, and the process proceeds to step S701. For example, when the threshold management ID of the threshold information is F001, the gender in the input data in which the gender is female is rewritten to male. The rewriting process is an example of substitution unit. According to the learned model 341, it is easier to approve a loan for male than female because there is a bias in the learned model 341 of the prediction system 102, just as the fairness management unit 302 performs the determination from the ratio and the threshold in step S704. Therefore, in the embodiment, it is easy for the learned model 341 of the prediction system 102 to determine approval by performing the rewriting as in step S705.

The description will now refer to FIG. 6. In step S603, the communication unit 307 of the fairness management system 101 requests the prediction system 102 to perform prediction. Here, the input data requested to be predicted is different from the input data requested to be predicted in step S601 in some cases. This is because the input data requested to be predicted is rewritten in the process of step S705 in some cases.

In step S604, the learned model 341 of the prediction system 102 performs prediction using the input data requested to be predicted and received in step S603 and determines whether to approve a loan. A prediction result of the learned model 341 obtained using the input data in which the gender is rewritten to “male” is a second prediction result.

In step S605, the communication unit 343 of the prediction system 102 responds to the fairness management system 101 with the prediction result predicted in step S604.

In step S606, the prediction result storage unit 304 of the fairness management system 101 adds records of the input data requested to be predicted in step S603 and the prediction result received in step S605 as prediction result information to the prediction result table shown in Table 2.

In step S607, the prediction result storage unit 304 of the fairness management system 101 updates the prediction result statistics table shown in Table 3 based on the input data requested to be predicted in step S603 and the prediction result received in step S605. For example, when the value of the item of the gender of the input data is female and the prediction result is approval, the prediction result storage unit 304 adds one to each of the number of applications and the number of approvals in the first row of the prediction result statistics table of Table 3.

In step S608, the communication unit 307 of the fairness management system 101 responds to the business system 103 with the prediction result received in step S605.

In step S609, the presentation unit 371 of the business system 103 generates a UI to display the prediction result received in step S608 in the pull-down 507 of the loan examination screen 500. When a staff member who examines the loan application receives the prediction result as it is, the staff member presses the button 508 of the loan examination screen 500 displayed on the browser for decision. When the staff member who examines the loan application wants a result different from the prediction result, the staff member changes an option by manipulating the pull-down 507, and then presses the button 508 for decision. When the presentation unit 371 of the business system 103 detects that the button 508 is pressed, the process proceeds to step S610.

In step S610, the communication unit 373 of the business system 103 transmits content input on the loan examination screen 500 as feedback data to the fairness management system 101 via the logical unit 372.

In step S611, the feedback data storage unit 306 of the fairness management system 101 stores the feedback data received in step S610 in the feedback data management table shown in Table 4. This process is an example of reception unit for receiving feedback to the second prediction result. In this way, when the learned model 341 is determined to be fair in step S704 and the content requested to be predicted is rewritten in step S705, the fairness can be guaranteed immediately.

Here, the prediction result table shown in Table 2 and the feedback data management table shown in Table 4 will be described further. The input data requested to be predicted in step S603 is stored in the prediction result table of Table 2. Therefore, the input data requested to be predicted after the rewriting in the process of step S602 is stored in the prediction result table. On the other hand, the input data requested to be predicted in step S601 is stored in the feedback data management table of Table 4. Since the input data is input data before the process of step S602, the input data before the rewriting in the process of step S602 is stored in the feedback data management table.

<Process of replacing learned model>

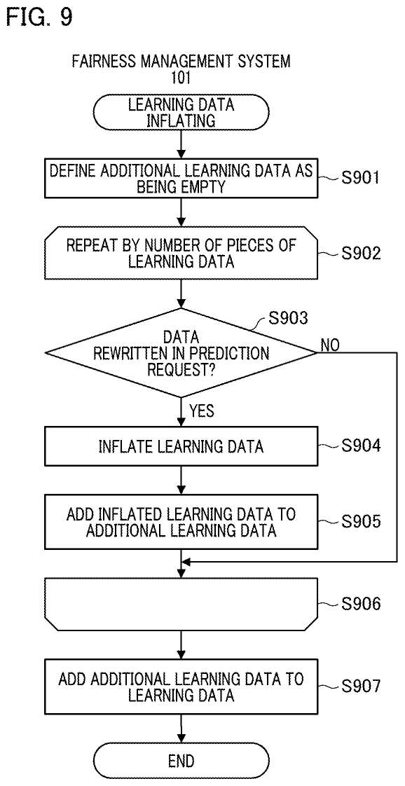

Next, a process in which the fairness management system 101 performs relearning of the learning model and the learned model 341 of the prediction system 102 is replaced will be described with reference to FIGS. 8 and 9.

FIG. 8 is a flowchart illustrating a process of replacing the learned model 341 of the prediction system 102 when the fairness management system 101 relearns a learning model. The process of the flowchart illustrated in FIG. 8 is performed when a fixed mm-iber of cases is stored in the feedback data management table of Table 4. In the embodiment, the number of cases is fixed, but is merely exemplary. For example, the process of FIG. 8 may be performed periodically. A process from steps S801 to S811 of FIG. 8 is a process performed by the fairness management system 101. A process from steps S851 and S852 of FIG. 8 is a process performed by the prediction system 102.

In step S801, the feedback data storage unit 306 acquires a fixed number of pieces of feedback data from the feedback management table of Table 4, and the process proceeds to step S802.

In step S802 the relearning unit 305 divides the feedback data acquired in step S801 into learning data and verification data, and the process proceeds to step S803. The verification data is data for verifying whether the learning model satisfies a condition as a learned model. In general, the verification data is prepared separately from the learning data without being used for learning.

In step S803, the relearning unit 305 inflates the learning data and the process proceeds to step S804. According to the embodiment, by inflating the learning data, relearning can be performed even before a large amount of feedback data gathers, and thus it is possible to generate the learned model which has been relearned more quickly. The details of the process of step S803 will be described below with reference to FIG. 9. The process of step S803 is a process performed as necessary. When a regulated amount of feedback data gather, the relearning may be performed without being inflated.

In step S804, the relearning unit 305 relearns a learned model in the same learning state as the learned model 341 of the prediction system 102 as a learning model using the learning data inflated in step S803, and the process proceeds to step S805. Since the feedback data used for the learning data includes a final result which is solution data, a SVM (support vector machine) which is supervised learning is used for relearning using some of the learning data as training data in the embodiment. In the present invention, the SVM is merely exemplary. Apart from that, any of various machine learning algorithms such as an algorithm and a neural network performing binary classification can be applied.

In step S805, the relearning unit 305 performs prediction with the learning model which has been relearned in step S804 using the verification data generated in step S802 as input data, and the process proceeds to step S806. The learning model which has been relearned is an example of a second model.

In step S806, the relearning unit 305 generates prediction result statistics information from the input data and the prediction result output in the process of step S805, and the process proceeds to step S807.

In step S807, the threshold storage unit 303 acquires one piece of threshold information from the threshold management table shown in Table 1, and the process proceeds to step S808.

In step S808, the fairness management unit 302 determines whether the threshold information can be acquired. When the fairness management unit 302 can acquire the threshold information the process proceeds to step S809. When the fairness management unit 302 cannot acquire the threshold information, the fairness management unit 302 determines that fairness can be guaranteed for all the threshold information, and the process proceeds to step S811.

In step S809, the fairness management unit 302 calculates a ratio from the prediction result statistics information generated in step S806, and the process proceeds to step S810. A ratio calculation method is the same as step S703.

In step S810, the fairness management unit 302 determines whether the ratio calculated in step S809 is less than the threshold of the threshold information acquired in step S807. This determination process is the same process as the process of step S704. This determination process is an example of determination unit for determining whether the result of the prediction in which a verification input by the second model is used satisfies a predetermined condition. When the ratio is less than the threshold, the fairness management unit 302 determines that fairness cannot be yet guaranteed for the learning model which has been relearned and ends the process. When the ratio is not less than the threshold, the fairness management unit 302 determines that fairness is guaranteed for the learning model which has been relearned with the threshold information acquired in step S807, and the process proceeds to step S807.

In step S811, the relearning unit 305 transmits the learning model which has been relearned as a learned model to the prediction system 102 via the communication unit 307, requests the prediction system 102 to replace the learned model 341, and ends the process.

In step S851, the communication unit 343 of the prediction system 102 monitors whether there is a request for replacing the learned model 341. When there is the request for replacing the learned model 341, the prediction system 102 causes the process to proceed to step S852. When there is no request for replacing the learned model 341, the prediction system 102 continues to monitor the request for replacing the learned model 341 in step S851.

In step S852, the learned model replacement unit 342 ends the process of replacing the learned model 341 of the prediction system 102 with the learned model received in step S8851. The replacement process is an example of replacement unit for replacing the first model with the second model. In this way, according to the embodiment, the learned model 341 can be replaced with the learned model which is generated through relearning using the feedback data and is in the state in which fairness can be guaranteed. The process of replacing the learned model with the learned model which is generated through the relearning and is in the state in which fairness can be guaranteed is an example of generation unit for generating the second model.

The details of the learning data inflating process (step S803) performed by the fairness management system 101 will be described with reference to FIG. 9. FIG. 9 is a flowchart illustrating a learning data inflating process. The inflating process is an example of generation unit for generating the learning data in which at least some values of the input overlap based on learning data formed by the input including the first input value and the second prediction result.

In step S901, the relearning unit 305 defines additional learning data as being empty, and the process proceeds to step S902.

The relearning unit 305 repeatedly perform the process from steps S902 to S906 by the number of pieces of learning data.

In step S903, the relearning unit 305 determines whether the prediction request is rewritten in the process of step S705 with regard to the learning data generated from the feedback data. When the prediction request is rewritten, the relearning unit 305 causes the process to proceed to step S904. When the prediction request is not rewritten, the relearning unit 305 causes the process to proceed to step S906.

In step S904, the relearning unit 305 inflates the learning data and the process proceeds to step S905. In the inflating, a value of a rewritten item is fixed and the other values are changed. For example, when the record in which the feedback data ID of Table 4 is D002 is learning data, data in which female of the gender rewritten in the process of step S705 is fixed and the values of the other items are rewritten is generated and used as the inflated learning data. As examples of the rewritten values of the other items, for example, the age is set to 30 years old and the income is set to 6,200,000 yen. Since the input data is rewritten to guarantee fairness in the process of step S705, learning data in which it is easy to guarantee fairness is generated by using the feedback data for inflation.

In step S905, the relearning unit 305 adds the learning data generated through the inflation in step S904 to additional learning data.

In step S907, the relearning unit 305 adds the additional learning data of step S905 to the learning data used for the relearning of step S804 and ends the process.

According to the present invention, as described above, the relearning unit 305 generates the learned model in which the input data is rewritten to guarantee fairness and the fairness can be guaranteed using the feedback data. Thus, according to the embodiment, it is possible to automatically replace the learned model with the learned model which has been relearned while being capable of guaranteeing fairness immediately.

The preferred embodiments of the present invention have been described above, but the present invention is not limited to these embodiments and various modifications and changes can be made within the scope of the gist of the present invention.

According to the present invention, it is possible to correct a bias of a learned model and guarantee fairness.

Other embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A system managing a first model generated by machine learning, the system comprising:
at least one processor and at least one memory functioning as:
a substitution unit configured to substitute a first input value included in an input with a second input value when a first prediction result which is a prediction result obtained using the input including the first input value by the first model satisfies a predetermined condition;
a preservation unit configured to preserve a second prediction result which is a prediction result obtained using an input obtained through the substitution by the first model:
a reception unit configured to receive feedback on the second prediction result; and
a generation unit configured to generate a second model by performing machine learning using first learning data formed by the input including the first input value and the second prediction result based on the received feedback.

2. The system according to claim 1, further comprising:
a determination unit configured to determine whether a prediction result obtained using a verification input by the second model satisfies the predetermined condition.

3. The system according to claim 2, further comprising:
a replacement unit configured to replace the first model with the second model if it is determined that the prediction result obtained using the verification input by the second model does not satisfy the predetermined condition.

4. The system according to claim 1, further comprising:
a data generation unit configured to generate second learning data in which at least some values of the input overlap based on the first learning data formed by the input including the first input value and the second prediction result, wherein the second model is generated by performing machine learning using the first learning data formed by the input including the first input value and the second prediction result in addition to the second learning data.

5. The system according to claim 1, wherein the predetermined condition is a condition that is satisfied when there is a bias between the prediction result obtained using the input including the first input value by the first model and a prediction result obtained using the input including the second input value by the first model.

6. The system according to claim 5,
wherein a ratio of a number of times that a prediction result predicted using the input including the first input value by the first model is a predetermined prediction result to a total prediction number predicted using the input including the first input value by the first model is set as a first ratio,
wherein a ratio of a number of times that a prediction result predicted using the input including the second input value by the first model is the predetermined prediction result to a total prediction number predicted using the input including the second input value by the first model is set as a second ratio, and wherein the predetermined condition is a condition in accordance with a ratio of the first ratio to the second ratio.

7. A method for a system managing a first model generated by machine learning, the method comprising:
substituting a first input value included in an input with a second input value when a first prediction result which is a prediction result obtained using the input including the first input value by the first model satisfies a predetermined condition;
preserving a second prediction result which is a prediction result obtained using an input obtained through the substitution by the first model;
receiving feedback on the second prediction result; and
generating a second model by performing machine learning using learning data formed by the input including the first input value and the second prediction result based on the received feedback.

8. A non-transitory storage medium storing on which is stored a program causing a computer to execute a method for a system managing a first model generated by machine learning, the method comprising:
substituting a first input value included in an input with a second input value when a first prediction result which is a prediction result obtained using the input including the first input value by the first model satisfies a predetermined condition;
preserving a second prediction result which is a prediction result obtained using an input obtained through the substitution by the first model;
receiving feedback on the second prediction result; and
generating a second model by performing machine learning using learning data formed by the input including the first input value and the second prediction result based on the received feedback.
